(19) United States
(12) Patent Application Publication
(10) Pub. No.: US 2014/0279383 A1
(43) Pub. Date: Sep. 18, 2014

(54) METHODS AND SYSTEMS RELATED TO LENDER MATCHING

(71) Applicant: GORDON*HOWARD ASSOCIATES, INC., Littleton, CO (US)

(72) Inventors: Gerald A. MORGAN, Littleton, CO (US); Stanley G. Schwarz, Indialantic, FL (US); Alan Vordermeier, JR., Wellington, FL (US)

(73) Assignee: GORDON*HOWARD ASSOCIATES, INC., Littleton, CO (US)

(21) Appl. No.: 13/828,440

(22) Filed: Mar. 14, 2013

(51) Int. Cl. G06Q 40/02

(52) U.S. Cl. CPC G06Q 40/025
USPC 705/38

(57) ABSTRACT

Lender Matching. At least some of the example embodiments are methods including: matching a loan applicant with at least one lending institution, the matching by a lead source service provider server, the matching comprising: providing the loan applicant with a matching software, the matching software for use on a handheld computing device; accepting a loan request from the loan applicant by way of a transmission from the matching software; filtering the loan request using at least one predetermined criteria; matching the loan request with at least one lending institution; and issuing an alert of a match indication to the handheld computing device.

### BACKGROUND

An applicant wishing to procure financing for a vehicle purchase or vehicle loan refinancing may submit a number of loan requests to a plurality of lending institutions. However, the process of filling out multiple loan requests, some of which may not be standard, can be time consuming and inefficient. In addition, lending institutions uninterested in providing financing may never inform the applicant. Thus, the applicant may be left wondering about the status of the loan request. Any process that makes filling in and submitting a loan request to lending institutions and receiving information from interested parties would be beneficial to a vehicle loan applicant.

### BRIEF DESCRIPTION OF THE DRAWINGS

For a detailed description of exemplary embodiments, reference will now be made to the accompanying drawings in which:

FIG. 1 shows a flow diagram illustrating steps of submitting a loan request to a lead source service provider via matching software in accordance with at least some embodiments;

FIG. 2 shows a screenshot of the matching software in accordance with at least some embodiments;

FIG. 3 shows, in block diagram form, a server in accordance with at least some embodiments;

FIG. 4 shows, in block diagram form, a computer system in accordance with at least some embodiments; and

FIG. 5 shows a flow diagram depicting an overall method in accordance with at least some embodiments.

### NOTATION AND NOMENCLATURE

Certain terms are used throughout the following description and claims to refer to particular system components. As one skilled in the art will appreciate, different companies may refer to a component and/or method by different names. This document does not intend to distinguish between components and/or methods that differ in name but not in function.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device that connection may be through a direct connection or through an indirect connection via other devices and connections.

“Remote” shall mean one kilometer or more.

“Debt-to-income (DTI) ratio” shall mean a percentage of gross monthly income that is used to pay debts.

“Front end debt-to-income ratio” shall mean a percentage of monthly gross income that is used to pay housing costs, where housing costs may include rent; mortgage payments, including principal, interest, and private mortgage insurance; insurance premiums, property taxes, and homeowners association fees.

“Back end debt-to-income ratio” shall mean a percentage of monthly gross income that is used to pay debt remaining after housing costs have been paid, including credit card payments; car loan payments; student loan payments; child support payments; alimony payments; and legal judgment payments.

“Lead” shall mean a loan request related to an applicant.

“Handheld computing device” shall mean a mobile computer comprising a wireless interface.

“Matching software” shall mean a type of software application for a computing device.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application.

Various embodiments are directed to systems and method of submitting a loan request for a vehicle loan to a lead source service provider server via a transmission from matching software executing on a handheld computing device. The developmental context is matching lending institutions to a loan request (i.e., a lead) seeking a vehicle purchase loan or vehicle refinance loan by way of a matching software, and thus the specification will be based on the development context; however, the developmental context shall not be read as a limitation as to the applicability of the various embodiments, as the methods described herein may apply to other lender/borrower situations.

The specification first turns to a high level overview. In one embodiment, an applicant seeking a loan for a new vehicle purchase or a vehicle loan refinance begins the process by downloading matching software to a handheld computing device, such as a smartphone or tablet computer. After the matching software is executed on the handheld computing device, the applicant registers for an account with the lead source service provider associated with the matching software. The applicant subsequently uses the registration information to sign in and then access the utility provided by the matching software. Once the matching software has been accessed, the applicant may provide information related to the acquisition of financing to create a loan request, as well as follow up on a submitted loan request.

Continuing with the process, the loan request includes the applicant's personal information, financial information, as well as information about the vehicle for which financing is to be acquired. Once the loan request is submitted, it can be thought of as a “lead.” The lead is submitted to a server associated with the lead source service provider, where the lead is then matched with potential lending institutions. If any lending institutions agree to consider the lead, the lead source service provider server notifies the applicant by way of the matching software, that the applicant has potential lending sources. The applicant may then take steps to secure financing. FIG. 1 shows a flow diagram illustrating the steps of finding willing lending institutions by way of matching software.

In particular, FIG. 1 steps through the matching process which begins when an applicant seeks funding for a vehicle purchase loan or refinance loan (block 100). The applicant downloads the matching software provided by the lead source service provider to a handheld computing device (block 102). The applicant registers for a lender matching account (block 104). The applicant accesses the matching software by signing in with the registration information (block 106). The applicant fills out a loan request with financial and personal information, as well as vehicle information (block 108). The loan request is securely transmitted from the matching software in the form of a lead to a lead source service provider server (block 110). The lead source service provider server matches the loan request to potential lending institutions (block 112). If a lending institution approves consideration of the lead, a notification of the match, or matches, is returned to the applicant via the matching software (block 114). The applicant is able to communicate with any of the matched lending institutions and/or delete the notification (block 116). The specification will now discuss each of the steps discussed above in more detail.

An applicant wishing to secure financing for the purchase of a new vehicle or to refinance an already existing vehicle loan, begins by downloading matching software provided by the lead source service provider to a handheld computing device. In one embodiment, the matching software may be downloaded by accessing an online application store (e.g., iTunes™ or the Google Play™ Store) from the handheld computing device. In another embodiment, the matching software may be downloaded on a laptop computer or desktop computer, and then transferred to the handheld computing device when the handheld computing device is synced with the laptop or desktop computer. Regardless of the method by which the matching software is obtained, the matching software is programmed in a way to communicate with a lead source service provider server through a wired or wireless connection. The communication link between the handheld computing device and the lead source provider server enables transfer of information between the applicant and a plurality of lending institutions.

Before the applicant can use the matching software, the applicant first registers for an account with the lead source service provider. In one embodiment, the applicant may register for an account on the lead source provider's website. In another embodiment, the applicant may download the matching software and register for an account through the matching software. Downloading and registering may be done by way of a wired or wireless transfer using a secure encrypted connection established by the lead source service provider server. When the applicant registers for an account, the applicant may be prompted to select a username and password in order to securely access the account. The username and password may be the same to access the account on a website as to access the account using the matching software. If the applicant has opted to sign up for an account on the lead source service provider's website, the applicant may access the matching software by signing in with pre-existing account information provided to the applicant during registration.

When the applicant accesses the matching software, the matching software communicates with the lead source service provider server to confirm and verify the applicant's account information by providing the lead source remote server provider with the applicant's identifying information, such as the applicant's cell phone number, IP address, or another unique identifier. After verification, the applicant may use the matching software. An example screenshot of the graphical user interface (GUI) of the matching software is shown in FIG. 2.

In particular, FIG. 2 shows a screenshot 200 of one potential screen of the matching software. In one embodiment, after the applicant has accessed and logged into the matching software, the applicant provides the matching software with information related to applying for vehicle loan financing. In another embodiment, which will be discussed later, the applicant accesses the matching software in order to receive later updated information related to lending matching.

A lead is created when the applicant submits the loan request through matching software. The applicant populates one or more forms with personal identifying information and financial information. Such population may be done manually, semi-automatically, or automatically. Semi-automatic or automatic population may be undertaken using pre-stored information or automatic completion (“auto-complete”) tools known to those of skill in the art.

In one embodiment, the applicant may provide personal information by selecting the example “personal data” menu item 202 shown in FIG. 2. Selecting may comprise, for example, by “clicking” on a hyperlink with a finger or a stylus, or by using a mechanism to control a cursor on the screen, such as a key press or mouse gesture. Although the loan request form is not entirely shown in the figure, the following personal information may be provided by the applicant:

Full name;

Social security number;

Current residential address and time at current residential address;

Date of birth;

Employment information, including employment status, and if employed, name of employer, address of employer, work telephone number;

Personal telephone numbers, including wired phone numbers and wireless phone numbers;

E-mail address;

Residential addresses of applicant and time at previous residential addresses;

Citizenship(s);

Marital Status;

Military rank, if any; and

Number of dependents.

In addition, the applicant may provide financial information by selecting the example “financial data” menu item 204 shown in FIG. 2. Although the loan request form is not entirely shown in the figure, the following financial information may be provided by the applicant:

Monthly gross salary;

Other monthly income;

Value of liquid assets;

Monthly housing payments. Housing payments may be rent, or may be mortgage payments, including principal, interest, and private mortgage insurance; insurance premiums; property taxes; and homeowners association fees; Credit score;

Whether the applicant has prior history of foreclosure on a residence;

Whether the applicant has a prior history of repossession on a vehicle;

Whether the applicant has a prior history of repossession on household items;

Whether applicant has a prior history of actions taken to collect monies due but unpaid; and

Whether applicant has filed for bankruptcy;

If the applicant is applying for the financing with a joint applicant, the personal and financial information of the joint applicant may also be provided.

In one embodiment, the applicant may fill out the loan request form directly within the matching software, such as by selecting the appropriate menus shown in FIG. 2. In another embodiment, the matching software may auto-fill some or all of the applicant's information from information already stored within the handheld computing device's memory. In yet another embodiment, the matching software may auto-fill some of the applicant's information from data stored in a remote database wirelessly connected to the handheld computing device. In yet still another embodiment, the applicant may fill in the application on the lead source provider's webpage, where the webpage may communicate with the matching software to fill in the information of the joint applicant may also be included on the application.

The loan request information may be organized and saved in a database, either locally in the handheld computing device's memory or the loan request information will be transmitted, such as in an encrypted Extensible Markup Language (XML) file, via wired or wireless transfer using a secure encrypted connection established by the lead source service provider server. A secure network connection may use a security certificate from the lead source service provider server, assuring data encryption. Once the loan request has been submitted, it can be thought of as a “lead.”

Once the lead is received, in one embodiment, the lead source service provider server may begin with an initial filtering process which discards the lead if it fails to meet one or more minimum thresholds. In one embodiment, the thresholds may be legal, such as a minimum age. In another embodiment, the thresholds may be established by the lending institutions.

After an initial filtering, the lead source service provider server may request a credit report on the applicant from a consumer reporting agency or credit bureau (such as Experian, Equifax, or Trans Union). The credit report is analyzed, and the applicant's creditworthiness, credit standing, veracity in light of information in the lead, and credit capacity is determined. In part, this determination may include consideration of a FICO score and whether the applicant has ever filed for bankruptcy or had a vehicle repossessed.

The lead source service provider server then communicates with a plurality of lending institutions to determine which, if any, of the lending institutions agree to consider the lead. The lending institution may accept or deny the lead by considering a set of factors which may influence the lending institutions decision to provide a loan. These factors may include the borrower's credit score; whether or not the borrower has filed for bankruptcy or had a vehicle repossessed; work history; time with an employer; collateral and liquid assets; monthly financial obligations; years at current address; total monthly salary; total monthly income; loan amount; down payment; credit score; loan to value; combined loan to value; front debt-to-income ratio; back debt-to-income ratio; time at current job; and loan type.

In one embodiment, after the lead source service provider server has received a predefined number of “accepted” responses from financing institutions, the lead source service provider server transmits a list comprised of lender institution matches to the matching software executing on the handheld computing device. In another embodiment, the lead source service provider server may send a notification to the matching software as each “accepted” response is received by the lead source service provider server.

The applicant may receive a text message (e.g., SMS) notification that matches have been received. In another embodiment, the applicant may receive an email message indicating matches have been received. In yet another embodiment, an icon displayed on the handheld computing device's display may change to show an “updated” status or a badge indicating the number of matches. For example, still referring to FIG. 2, the applicant may receive a notification 212 showing that three matches have been received. In one embodiment, the badge notification is overlaid on top of a “matches” menu button 210.

The applicant may review each of the lending institutions that accepted the applicant's lead for further consideration by selection the “matches” menu button 210. Once the applicant selects the matches menu, an interactive list 214 of matches may be displayed. The applicant may opt to communicate with any number of the matches. In one embodiment, the applicant may communicate with at least one of the lending institutions using a hyperlinked phone number which will directly dial the associated lending institution. In another embodiment, the applicant may select a hyperlinked electronic mail (“e-mail”) address which may open the applicant's email program, enabling the applicant to send the lending institution an e-mail directly. In another embodiment, the application may have a standard e-mail linked to the applicant's email address and clicking on the hyperlinked e-mail may automatically send out a previously composed e-mail.

Once the applicant has reviewed the matches and communicated with the lending institutions, the applicant may delete one, some, or all of the matches sent to the handheld computing device. In yet another embodiment, the applicant may opt to delete matches that are a number of days old (e.g. all matches from over 30 days ago).

In addition to matching a loan request with a lending institution, the matching software may also provide the applicant with additional information and tools related to obtaining a loan. The applicant may access these additional tools by selecting an example “tools” menu button 208, such as the one shown in FIG. 2. In one embodiment, the additional tools may include a down payment calculator which may assist the applicant in determining an amount to borrow. The matching software may access data from the applicant's personal information (e.g., salary), as well as information about the vehicle (e.g., value, cost). The matching software may also access data from information provided by the matched lending institutions, such as down payment requirements or interest rates. The data may be integrated with the down payment calculator to assist the applicant in making decisions.

Furthermore, the matching software may communicate with third-party services in order to provide the applicant with more information. For example, the matching software may connect to a third-party valuation service such as Kelley Blue Book, in order to obtain the trade-in, resale, or retail value of a vehicle. The trade-in, resale, or retail value may be retrieved, and in one embodiment, automatically enter the data into the applicant's loan request by the matching software to be used when submitting the loan request.

Turning now to FIG. 3, FIG. 3 shows, in block diagram form, an overall system in accordance with at least some embodiments. In particular, an example of the lead source service provider server 300. The server 300 may comprise a processor 306 and a non-transitory computer-readable storage 302 which may store a server-side lender matching software 304. The processor 306 also couples to a network interface 308, which enables network communications between the server 300 and the handheld computing device 314, as well enabling communications with lending institutions 312 and third parties 310.

Server 300 may take any suitable form. As illustrated, the server 300 is a standalone computer system operated as a server. In other cases, the server 300 may be a group of computer systems operated in a parallel manner to provide services to the handheld computing device 314. In yet still other cases, the server 300 may be located on the “cloud” such that the precise physical location of the functions provided by the server is not specifically known to the users and/or may change depending on the loading and usage.

FIG. 4 shows, in block diagram form, a computer system 400 in accordance with at least some embodiments. In one embodiment, computer system 400 may be a handheld computing device such as a smartphone, a tablet computer, or a personal digital assistant. In another embodiment, computer system 400 may be a server such as the lead source service provider server 300. Computer system 400 comprises a processor 420 connected to a memory bridge 403.

System memory 402, which is connected to processor 420 by way of memory bridge 404, functions as the working memory for the processor, and comprises a memory device or array of memory devices in which programs, instructions and data are stored. System memory 402 may comprise any suitable type of memory such as dynamic random access memory (DRAM) or any of the various types of DRAM devices such as synchronous DRAM (SDRAM), or extended data output DRAM (EDODRAM). System memory 402 is an example of a non-transitory computer-readable medium storing programs and instructions, and other examples of a non-transitory computer-readable medium may include disk drives (e.g. hard drives or solid-state drives) and flash memory devices.

Memory bridge 404 is also connected to an input/output (I/O) bridge 406 via a bus or other communication path. The I/O bridge 404 controls many computer system functions, such as interfacing with various input devices 412, (e.g., a keyboard, mouse, game controller, serial ports, floppy drives, and disk drives). Further, I/O bridge 406 may be coupled to a network interface 408, which enables computer system 400 to communicate with other computer systems via an electronic communications network, and may include wired or wireless communication over local area networks, wide area networks, and/or the Internet.

Other components, including universal serial bus (USB) ports or other communication port connections (e.g., RS323, RS485, Fire Wire) may also be supported by the I/O bridge 406.

The computer system 400 further comprises a display processor 410 which, in the example system of FIG. 4, is coupled to the memory bridge 404. In one embodiment, display processor 410 is a graphics subsystem that includes at least one graphics processing unit (GPU) and graphics memory. Display processor 410 couples to display device 414. The graphics processing unit (which may be part of display processor 410) may comprise an onboard processor, as well as onboard memory (not shown as to not unduly complicate the figure). The onboard processor may perform graphics processing, as commanded by CPU 420.

System disk 416 is coupled to I/O bridge 206 and may be configured to store content, applications, and data for use by processor 420. System disk 416 provides non-volatile storage for applications and data and may include fixed or removable hard disk drives, flash memory devices, and other magnetic, optical, or solid state storage devices. Computer system 400 may include, but is not limited to, personal desktop computers, laptop computer, servers, smartphones, web enabled television, tablet computing devices, or any other device having web browser software and a network interface.

The method of matching lenders to a loan applicant by way of a matching software will now be discussed in more detail. FIG. 5 shows a flow diagram depicting an overall method. The method starts (block 500) with matching a loan applicant with at least one lending institution, the matching by a lead source service provider server (block 502). The matching comprising providing the loan applicant with matching software, the matching software for use on a handheld computing device (block 504); accepting a loan request from the loan applicant by way of a transmission from the matching software (block 506); filtering the loan request using at least one predetermined criteria (block 508); matching the loan request with at least one lending institution (block 510); and issuing an alert of a match indication to the handheld computing device (block 512). Thereafter, the method ends (block 514).

From the description provided herein, those skilled in the art are readily able to combine software created as described with appropriate general-purpose or special-purpose computer hardware to create a computer system and/or computer sub-components in accordance with the various embodiments, to create a computer system and/or computer sub-components for carrying out the methods of the various embodiments and/or to create a non-transitory computer-readable medium (i.e., not a carrier wave) that stores a software program to implement the method aspects of the various embodiments.

References to “one embodiment,” “an embodiment,” “some embodiments,” “various embodiments”, or the like indicate that a particular element or characteristic is included in at least one embodiment of the invention. Although the phrases may appear in various places, the phrases do not necessarily refer to the same embodiment.

The above discussion is meant to be illustrative of the principles and various embodiments of the present invention. Numerous variations and modifications will become apparent to those skilled in the art once the above disclosure is fully appreciated. For example, the various embodiments have been described in terms of matching software programmed to return matching lending institutions with a vehicle loan. This context, however, shall not be read as a limitation as to the scope of one or more of the embodiments described—the same techniques may be used for other embodiments. It is intended that the following claims be interpreted to embrace all such variations and modifications.

What is claimed is:

1. A method comprising:
matching a loan applicant with at least one lending institution, the matching by a lead source service provider server, the matching comprising:
providing the loan applicant with a matching software, the matching software for use on a handheld computing device;
accepting a loan request from the loan applicant by way of a transmission from the matching software;
filtering the loan request using at least one predetermined criteria;
matching the loan request with at least one lending institution; and
issuing an alert of a match indication to the handheld computing device.

2. The method of claim 1 further comprising receiving a request from the loan applicant to register an account with the lead source service provider server.

3. The method of claim 2 wherein the loan applicant sends the request from the matching software downloaded onto the handheld computing device.

4. The method of claim 1 further comprising wherein the matching software encrypts the loan request prior to submitting the loan request to the lead source service provider server.

5. The method of claim 1 wherein matching the loan request with at least one lending institution further comprises matching a plurality of predetermined personal criteria.

6. The method of claim 1 wherein matching the loan request with at least one lending institution further comprises matching a plurality of predetermined financial criteria.

7. The method of claim 1 wherein filtering the loan request further comprises filtering based on a minimum age.

8. The method of claim 1 wherein issuing the alert further comprises issuing the alert by at least one from the group consisting of: a short message service (SMS); an electronic mail message; and a matching software notification.

9. The method of claim 1 wherein the accepting the loan request further comprises accepting the loan request by way of a wireless transmission.

10. The method of claim 1 wherein the accepting the loan request further comprises accepting the loan request by way of a wired transmission.

11. A server comprising:
a processor;
a memory coupled to the processor, the memory storing a program that, when executed by the processor, causes the processor to:
provide a loan applicant with a matching software, the matching software for use on a handheld computing device;
accept a loan request from the loan applicant by way of a transmission from matching software;
submit the loan request to a lending institution by way of a transmission;
sending an alert indicating at least one match between the loan request and a lending institution to the handheld computing device.

12. The server of claim 11 wherein when the processor receives the alert, the program further causes the processor to receive the alert by way of at least one of the group comprising: a short message service (SMS); an electronic mail message; and a matching software notification.

13. The server of claim 11 wherein the handheld computing device is at least one selected from the group comprising: a smartphone; a personal digital assistant; and a tablet computer.

14. The server of claim 11 wherein the processor further causes the program to encrypt the loan request prior to submitting the loan request to the lead source service provider server.

15. The server of claim 11 wherein the processor further causes the program to receive a request from the loan applicant to register an account with the lead source service provider server.

16. A non-transitory computer-readable medium storing instructions that, when executed by a processor, cause the processor to:
provide a loan applicant with a matching software, the matching software for use on the handheld computing device;
accept a loan request from the loan applicant by way of a transmission from the matching software;
submit the loan request to a lending institution by way of a transmission;
send an alert indicating at least one match between the loan request and a lending institution to the handheld computer device.

17. The non-transitory computer-readable medium of claim 16 wherein when the processor receives the alert, the instructions further cause the processor to receive the alert by way of at least one of the group comprising: a short message service (SMS); an electronic mail message; and matching software notification.

18. The non-transitory computer-readable medium of claim 16 wherein the instructions further causes the processor to encrypt the loan request prior to submitting the loan request to the lead source service provider server.

19. The non-transitory computer-readable medium of claim 16 wherein the instructions further cause the processor the processor to receive a request from the loan applicant to register an account with the lead source service provider server.
